(19) United States
(12) Patent Application Publication
(10) Pub. No.: US 2026/0190100 A1
(43) Pub. Date: Jul. 2, 2026

(54) CONCURRENT SWITCHING OF TRANSMIT (TX) CHAINS BETWEEN MULTIPLE FREQUENCY BANDS

(71) Applicant: QUALCOMM Incorporated, San Diego, CA (US)

(72) Inventors: Timo Ville VINTOLA, San Diego, CA (US); Tarandeep VIRK, San Diego, CA (US); Yiqing CAO, Beijing (CN); Chu-Hsiang HUANG, San Diego, CA (US); Peter GAAL, San Diego, CA (US)

(21) Appl. No.: 19/129,212

(22) PCT Filed: Feb. 4, 2023
(86) PCT No.: PCT/CN2023/074487

§ 371 Date: May 12, 2025

(51) Int. Cl. H04W 72/0453; H04L 5/00

(52) U.S. Cl. CPC H04W 72/0453; H04L 5/0096

(57) ABSTRACT

Certain aspects of the present disclosure provide a method for wireless communications at a user equipment (UE). The UE may output for transmission signaling indicating a first time duration. The UE may concurrently switch transmit (TX) chains between multiple frequency bands during at least the first time duration. The multiple frequency bands may include three or more frequency bands. A value of the first time duration may be based on a capability of the UE.

### BACKGROUND

### Field of the Disclosure

Aspects of the present disclosure relate to wireless communications, and more particularly, to techniques for determining a time duration for concurrent switching of transmit (TX) chains between multiple frequency bands.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes outputting, for transmission, signaling indicating a first time duration; and concurrently switching transmit (TX) chains between multiple frequency bands during at least the first time duration.

Another aspect provides a method for wireless communications at a network entity. The method includes obtaining, from a UE, signaling indicating a first time duration for the UE to concurrently switch TX chains between multiple frequency bands; and communicating with the UE, in accordance with the indication.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIGS. 4A, 4B, 4C, and 4D depict various example aspects of data structures for a wireless communications network.

FIG. 5A depicts a first transmit (TX) chain associated with a frequency band A and a second TX chain associated with a frequency band B.

FIG. 5B depicts a first TX chain associated with a frequency band C and a second TX chain associated with the frequency band C.

FIG. 6 depicts example timing diagram of different power amplifiers (PAS) associated with different frequency bands during concurrent switching of first and second TX chains to a same frequency band.

FIG. 7 depicts example switching time periods for concurrent switching of first and second TX chains to a same frequency band.

FIG. 8 depicts example switching time periods for concurrent switching of first and second TX chains to different frequency bands.

FIG. 9 depicts example switching time periods for non-concurrent switching of first and second TX chains to a same frequency band.

FIG. 10 depicts example switching time periods for non-concurrent switching of first and second TX chains to different frequency bands.

FIG. 11 depicts example switching time periods for switching of first and second TX chains to a same frequency band, with a different length and a trigger time for switching of the first and second TX chains to the same frequency band.

FIG. 12A depicts a first TX chain associated with a frequency band A and a second TX chain associated with a frequency band B.

FIG. 12B depicts a first TX chain associated with a frequency band C and a second TX chain associated with a frequency band B.

FIG. 13 depicts example timing diagram of different PAs associated with different frequency bands during switching of first and second TX chains.

FIG. 14 depicts example switching time periods for switching of first and second TX chains.

FIG. 15 depicts a call flow diagram illustrating example communication among a UE and a network entity.

FIG. 16 depicts a method for wireless communications at a UE.

FIG. 17 depicts a method for wireless communications at a network entity.

FIGS. 18 and 19 depict aspects of example communications devices.

### DETAILED DESCRIPTION

Aspects of the present disclosure provide apparatuses, methods, processing systems, and computer-readable mediums for managing concurrent (or simultaneous) switching (or swapping) of transmit (TX) chains between multiple frequency bands.

Usually, a user equipment (UE) includes a radio frequency (RF) transceiver. The RF transceiver is used for establishing and maintaining an active connection with a network entity. The RF transceiver may be embodied in an RF modem, and includes one or more transmit (TX) chains and one or more receive (RX) chains to support bi-directional communication. A TX chain may include modulators, encoders, amplifiers and other devices and circuits.

Typically, the UE is configured with two TX chains associated with two frequency bands. The UE may implement a TX chain switching scheme to switch the two TX chains between the two frequency bands during a switching time duration, which corresponds to an interval or period of time to switch the TX chains. Currently, the switching time duration is defined per frequency band pair, so the UE can state to the network entity the switching time duration the UE needs to switch the TX chains only when two frequency bands are involved. The switching time duration values per frequency band pair may be 35, 140, or 210 microseconds.

In some cases, the UE can be configured to support more than two frequency bands. In such cases, the UE may also be configured with more than two TX chains. When the UE supports more than two frequency bands, the UE may have to switch the TX chains between these numerous frequency bands. Since the UE is currently only able to determine (e.g., based on one of the defined values per frequency band pair such as 35, 140, or 210 microseconds) and state the switching time duration the UE needs for switching the TX chains between the two frequency bands, there is a need for a technique for the UE to determine how fast the UE can switch the TX chains between the numerous frequency bands.

Techniques proposed herein may be implemented to determine (and communicate to a network entity) a switching time duration (or period) for a concurrent switching of TX chains between numerous frequency bands. For example, when a UE determines about a potential occurrence of the concurrent switching of the TX chains between the numerous frequency bands, the UE may determine that more switching time is required (e.g., in addition to one of defined values per frequency band pair such as 35, 140, or 210 microseconds) to concurrently switch the TX chains between the numerous frequency bands. The UE may calculate the additional switching time based on one or more factors including, but not limited to, an internal configuration of the UE.

For example, in certain cases, although the UE may need the additional switching time to perform the concurrent switching of the TX chains between the numerous frequency bands, however, in some of these cases, the UE may actually be able to perform the switching in a less amount of time depending on what UE internal changes are needed based on the internal configuration of the UE. Accordingly, the techniques proposed herein enable the UE to usually leverage a fast switch time of the TX chains between the numerous frequency bands (and thereby preventing any throughput loss or reduced capacity), but also allow sufficient time when multiple operations may be needed.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

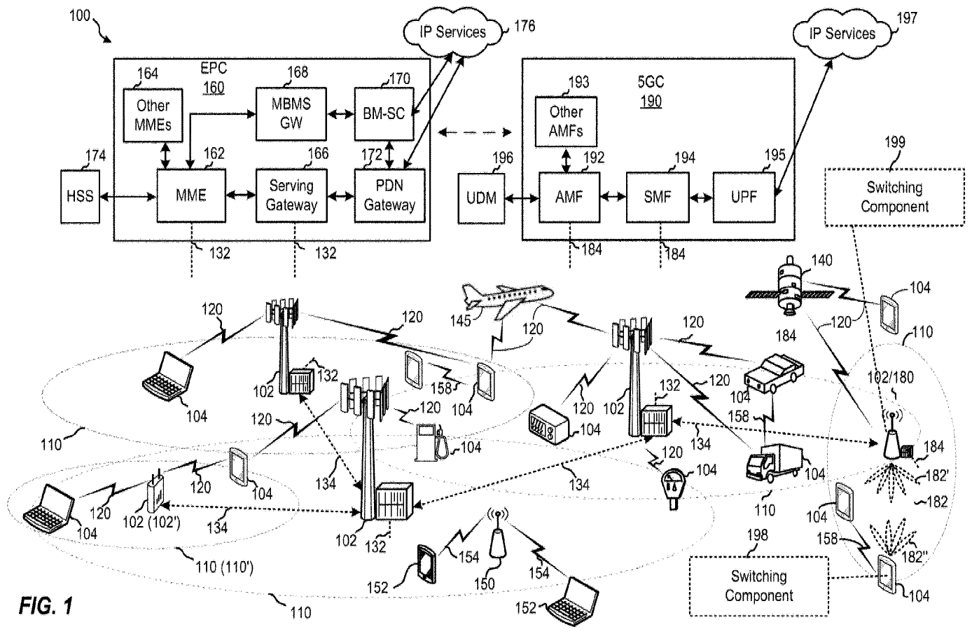

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

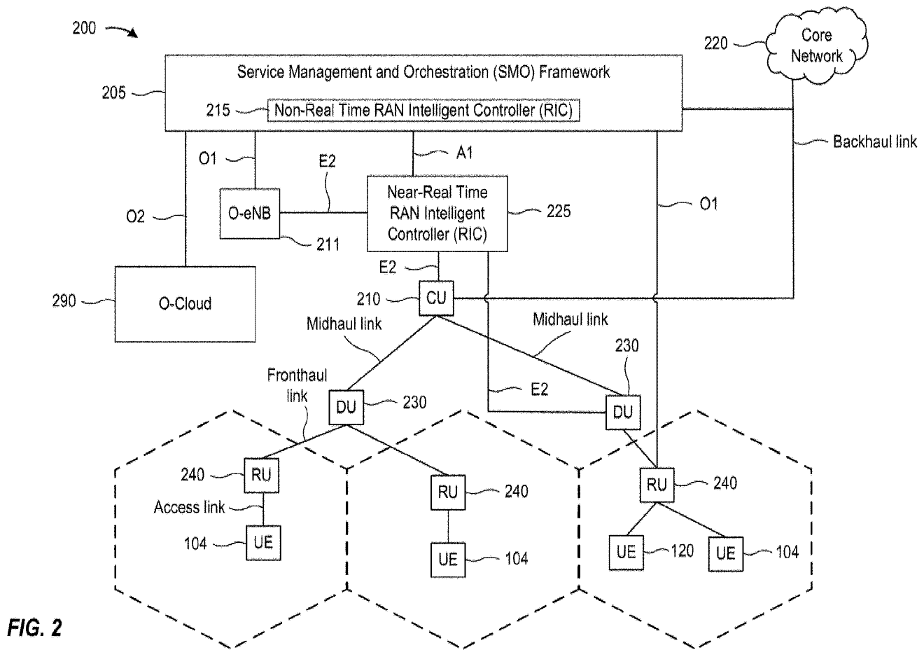

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1 ) as including 600 MHz-6 GHz, which is often referred to (interchangeably) as “Sub-6 GHZ”. Similarly, 3GPP currently defines Frequency Range 2 (FR2) as including 26-41 GHz, which is sometimes referred to (interchangeably) as a “millimeter wave” (“mmW” or “mm Wave”). A BS configured to communicate using mm Wave/near mm Wave radio frequency bands (e.g., a mm Wave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

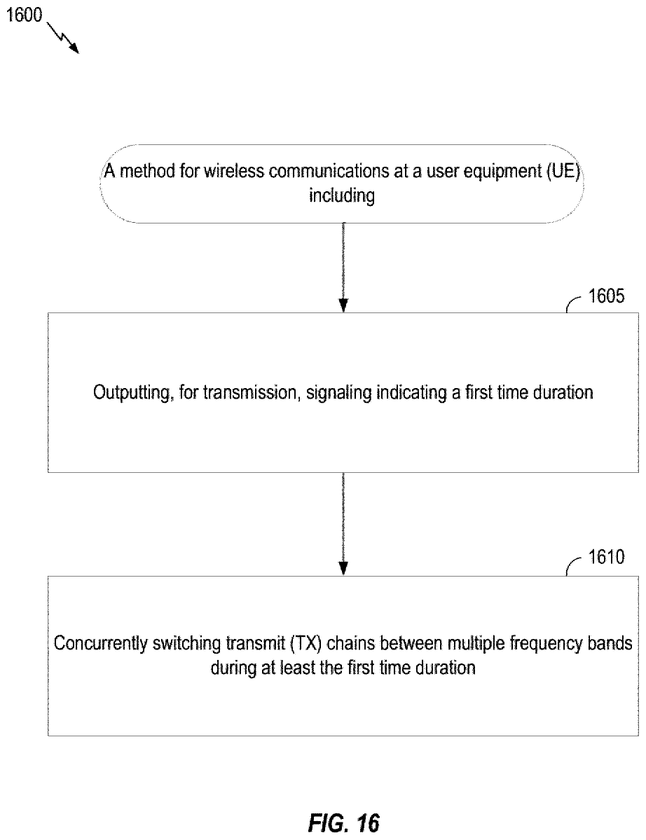

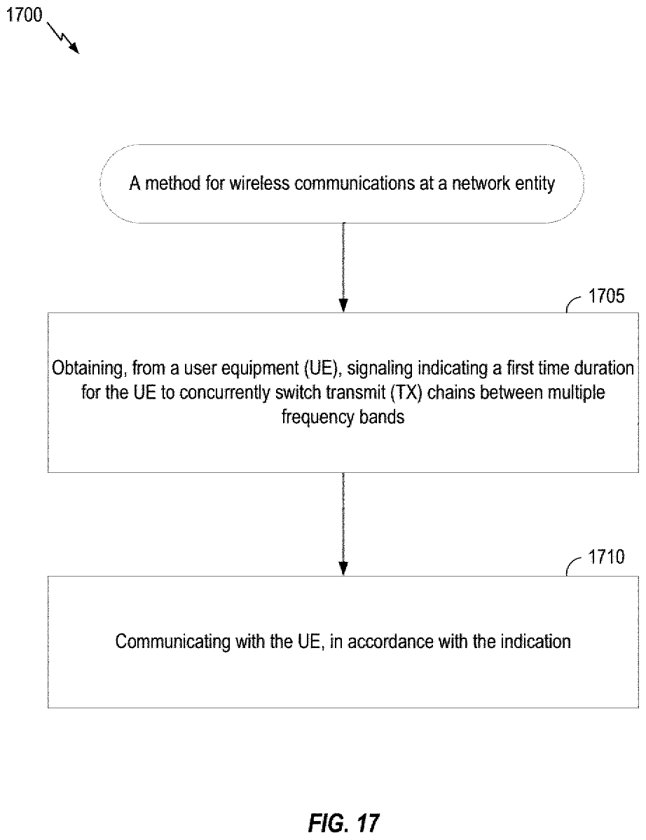

Wireless communication network 100 further includes switching component 198, which may be configured to perform method 1600 of FIG. 16. Wireless communication network 100 further includes switching component 199, which may be configured to perform method 1700 of FIG. 17.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an Ol interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as Al policies).

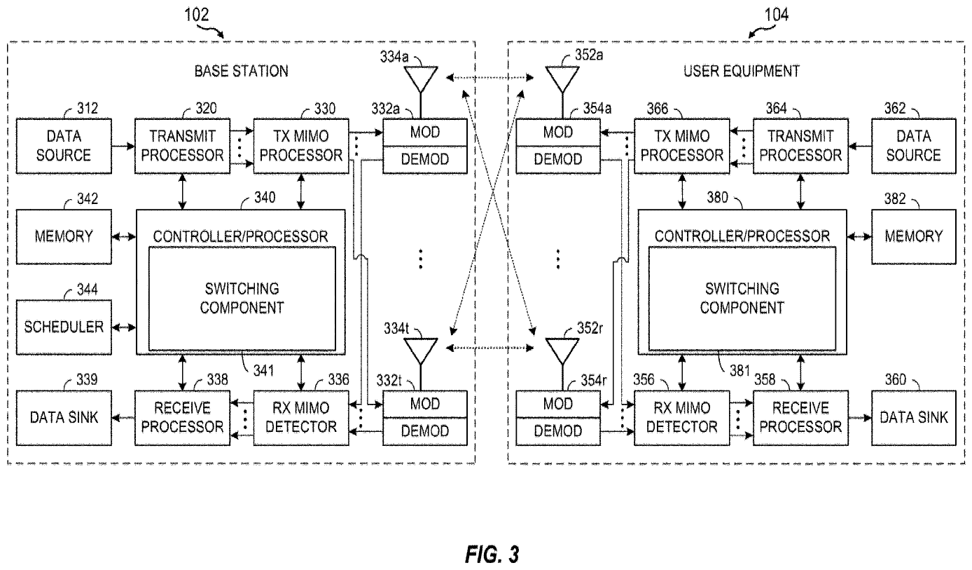

FIG. 3 depicts aspects of an example BS 102 and a UE 104.

Generally, BS 102 includes various processors (e.g., 320, 330, 338, and 340), antennas 334a-t (collectively 334), transceivers 332 a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes switching component 341, which may be representative of switching component 199 of FIG. 1. Notably, while depicted as an aspect of controller/processor 340, switching component 341 may be implemented additionally or alternatively in various other aspects of BS 102 in other implementations.

Generally, UE 104 includes various processors (e.g., 358, 364, 366, and 380), antennas 352 a-r (collectively 352), transceivers 354 a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes switching component 381, which may be representative of switching component 198 of FIG. 1. Notably, while depicted as an aspect of controller/processor 380, switching component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332 a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354 a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

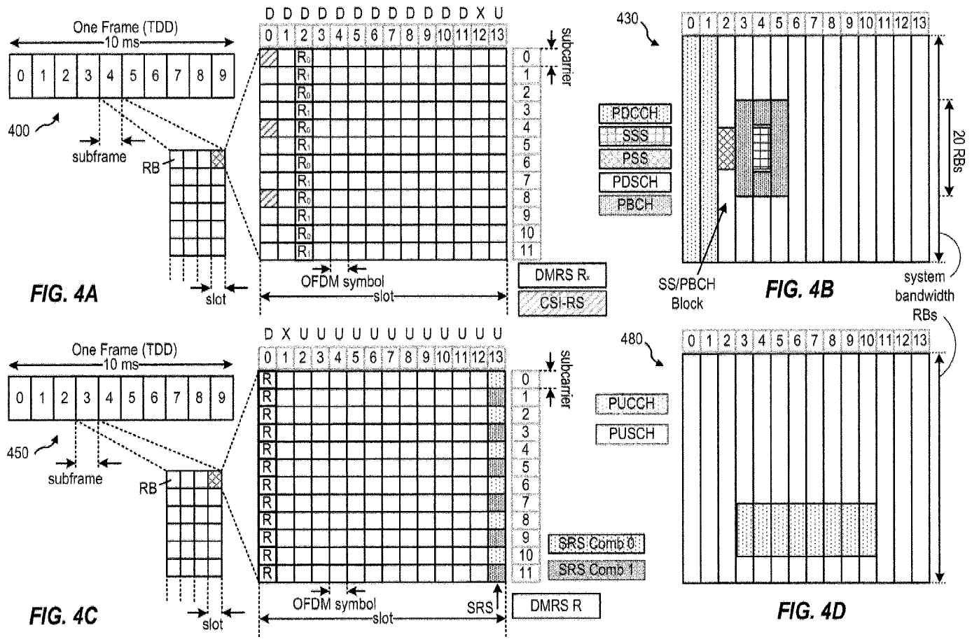

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Mmwave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3rd generation partnership project (3GPP) standards. For example, 3GPP technical standard TS 38.101 currently defines Frequency Range 1 (FR1 ) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mm Wave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Switching of Transmit (TX) Chains Between Frequency Bands

A user equipment (UE) includes a radio frequency (RF) transceiver. The RF transceiver may be operated independently, and used for establishing and maintaining an active connection with a network entity. The RF transceiver may be embodied in an RF modem, and includes at least one transmit (TX) chain and at least one receive (RX) chain to support bi-directional communication. The RF modem may assign the RX chains and the TX chains for each RF transceiver. A TX chain may include modulators, encoders, amplifiers and other devices and circuits. An RX chain may include amplifiers, demodulators, decoders and other devices and circuits.

The TX chains may also be called as baseband chains or RF TX chains. The TX chains enable active and multiple transmissions. For example, when the UE has two TX chains, the UE is enabled to have two transmissions at a same time.

In current systems, the UE is configured with two TX chains associated with two frequency bands. For example, a first TX chain of the UE is associated with a first frequency band and a second TX chain of the UE is associated with a second frequency band. The UE implements a TX chain switching scheme to switch the two TX chains between the two frequency bands (e.g., may be based on supplementary uplink (SUL) and/or new radio (NR) inter-band uplink carrier aggregation (CA) band combination). In some cases, the TX chain switching scheme may enable the switching between different transmissions such as two-layer transmissions and single-layer transmissions.

A switching time duration corresponds to an interval or period of time the UE takes to switch the TX chains. Currently, the switching time duration is defined per frequency band pair. In one example, the switching time duration for the TX chains per frequency band pair is 35 microseconds (usec). In another example, the switching time duration for the TX chains per frequency band pair is 140 usec. In yet another example, the switching time duration for the TX chains per frequency band pair is 210 usec.

The UE determines and communicates a value of the switching time duration the UE needs for switching the TX chains to the network entity. However, this ability of the UE to determine and communicate the value of the switching time duration to the network entity is limited. For example, the UE is able to determine (e.g., based on one of the defined values per frequency band pair noted above) and communicate the determined value of the switching time duration the UE needs for switching the TX chains to the network entity, when the switching of the TX chains is only between the two frequency bands. In other words, the UE can state the switching time duration the UE needs to switch the TX chains between the two frequency bands only when two frequency bands are involved, and therefore the switching is always between the same frequency bands.

The UE can be configured to support more than two frequency bands. To support more than two frequency bands, the UE may also be configured with more than two TX chains. When the UE supports more than two frequency bands, the UE may have to switch the TX chains between these numerous frequency bands. Since the UE is currently only able to determine (e.g., based on one of the defined values per frequency band pair noted above) and state the switching time the UE needs for switching the TX chains between the two frequency bands, there is a need for a technique for the UE to determine (and communicate to the network entity) how fast the UE can switch the TX chains between the numerous frequency bands. This determination is necessary because while the UE is switching the TX chains between any two or more frequency bands, the UE is not able to transmit at any other frequency band as well. So, during the switching time duration, no uplink transmissions are possible. Accordingly, it is vital for the UE to optimize the switching time duration for the switching of the TX chains between the numerous frequency bands to minimize impact to a network capacity.

### Overview of Concurrent and Non-Concurrent Switching of Transmit (TX) Chains Between Numerous Frequency Bands

A user equipment (UE) may be configured to support numerous frequency bands. The UE may implement a transmit (TX) chain switching scheme to switch TX chains between the numerous frequency bands. In one example, when there are more than two frequency bands, two different independent or dependent TX chain switching instances can occur which are overlapping with time, in response to the implementation of the TX chain switching scheme. In another example, while the switching of the TX chains is happening between certain frequency bands in response to the implementation of the TX chain switching scheme, other frequency bands may be utilized by the UE for transmitting since these other frequency bands are not part of the switching process.

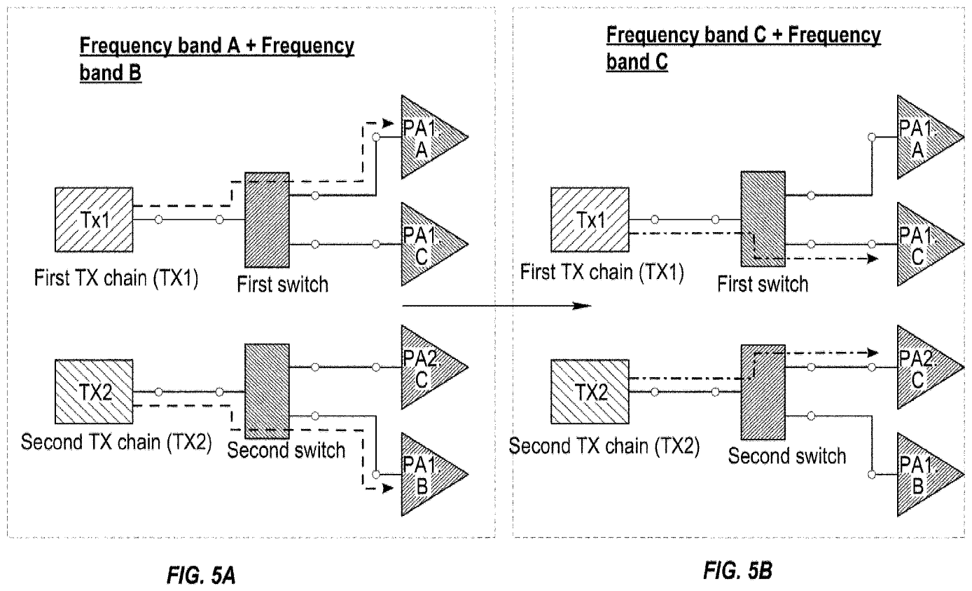

FIG. 5A depicts a first TX chain (TX1) of a UE associated with a frequency band A of a set of frequency bands and a second TX chain (TX2) of the UE associated with a frequency band B of the set of frequency bands. The set of frequency bands may also include a frequency band C and a frequency band D.

As further depicted in FIG. 5A, the first TX chain is associated with a first power amplifier (PA) associated with the frequency band A (e.g., PA1.A) via a first switch. The first switch and the first PA associated with the frequency band A may be connected via a bus such as a serial bus. The second TX chain is associated with a first PA associated with the frequency band B (e.g., PA1.B) via a second switch. The second switch and the first PA associated with the frequency band B may be connected via the serial bus.

The UE may implement a TX chain switching scheme to switch the first and the second TX chains between the set of frequency bands. For example, the UE may (e.g., via the first switch) switch the first TX chain from its association with the frequency band A to the frequency band C. The UE may (e.g., via the second switch) also switch the second TX chain from its association with the frequency band B to the frequency band C.

When the switching operation is completed after a certain switching time duration, the first TX chain is associated with the frequency band C and the second TX chain is also associated with the frequency band C. For example, as illustrated in FIG. 5B, the first TX chain is associated with a first PA associated with the frequency band C (e.g., PA1.C) via the first switch. The first switch and the first PA associated with the frequency band C may be connected via the serial bus. The second TX chain is associated with a second PA associated with the frequency band C (PA2.C) via the second switch. The second switch and the second PA associated with the frequency band C may be connected via the serial bus.

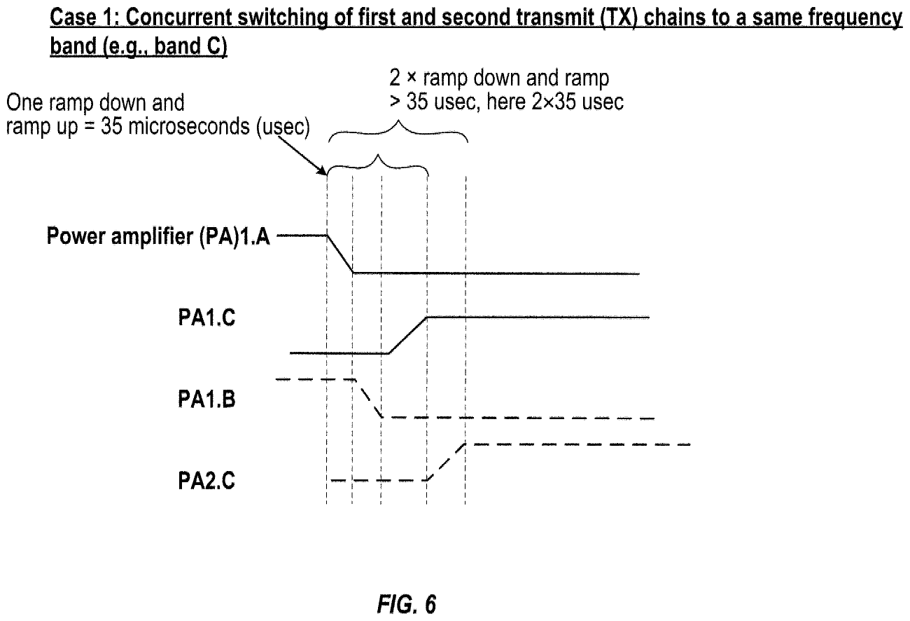

FIG. 6 depicts example timing diagram of different PAs associated with different frequency bands during concurrent switching of first and second TX chains of a UE to a same frequency band C (e.g., shown in FIG. 5A and FIG. 5B).

The UE is able to execute one switching command (e.g., via a TX chain switching scheme) at a time. For example, to switch the first and second TX chains to the same frequency band C, the UE may initially execute a first command to switch the first TX chain associated with the frequency band A to the frequency band C. The UE may then execute a second command to switch the second TX chain associated with the frequency band B to the frequency band C.

As depicted in FIG. 6, after the first command, there is a ramp down of a first PA associated with the frequency band A (e.g., PA1.A) followed by a ramp up of a first PA associated with the frequency band C (e.g., PA1.C). The time duration of the ramp down and the ramp up operation (or the switching time duration from the frequency band A to the frequency band C) is 35 usec (e.g., which is one of the defined values per frequency band pair).

After the second command (which is executed after the first command), there is a ramp down of a first PA associated with the frequency band B (e.g., PA1.B) followed by a ramp up of a second PA associated with the frequency band C (e.g., PA2.C). The time duration of the ramp down and the ramp up operation (or the switching time duration from the frequency band B to the frequency band C) is 70 usec (which is not one of the defined values per frequency band pair).

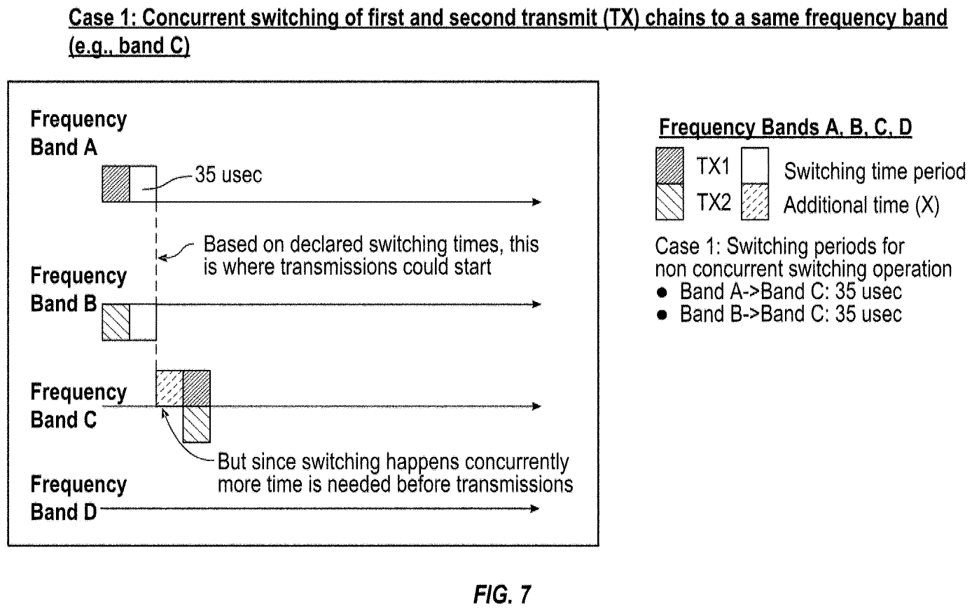

FIG. 7 depicts example switching time periods for concurrent switching of a first TX chain of a UE associated with a frequency band A and a second TX chain of the UE associated with a frequency band B to a same frequency band C (e.g., shown in FIG. 5A and FIG. 5B). As depicted in FIG. 7, since the switching between the first TX chain associated with the frequency band A and the second TX chain associated with the frequency band B to the same frequency band C occur at a same time, additional or more time is needed (e.g., beyond a defined time duration per frequency band pair (e.g., 35 usec)) to complete the switching process before uplink transmissions can be started. The additional time is required because, as depicted in FIG. 6, since the switching process of different TX chains start at different times, the concurrent switching process can not be completed during one of the defined time durations per frequency band pair.

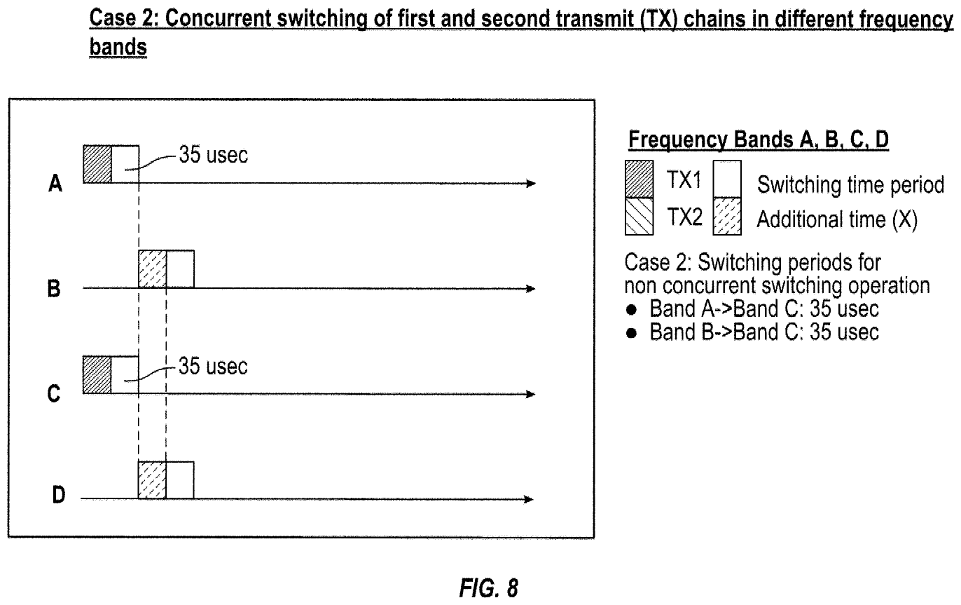

FIG. 8 depicts example switching time periods for concurrent switching of a first TX chain of a UE associated with a frequency band A and a second TX chain of the UE associated with a frequency band B to different frequency bands such as a frequency band C and a frequency band D. As depicted in FIG. 8, since the switching between the first TX chain associated with the frequency band A to the frequency band C and the second TX chain associated with the frequency band B to the frequency band D occur at a same time, additional or more time is needed (e.g., beyond a defined time duration per frequency band pair (e.g., 35 usec)) to complete the switching process before uplink transmissions can be started. The additional time is required because since the switching process of different TX chains start at different times, the concurrent switching process can not be completed during one of the defined time durations per frequency band pair.

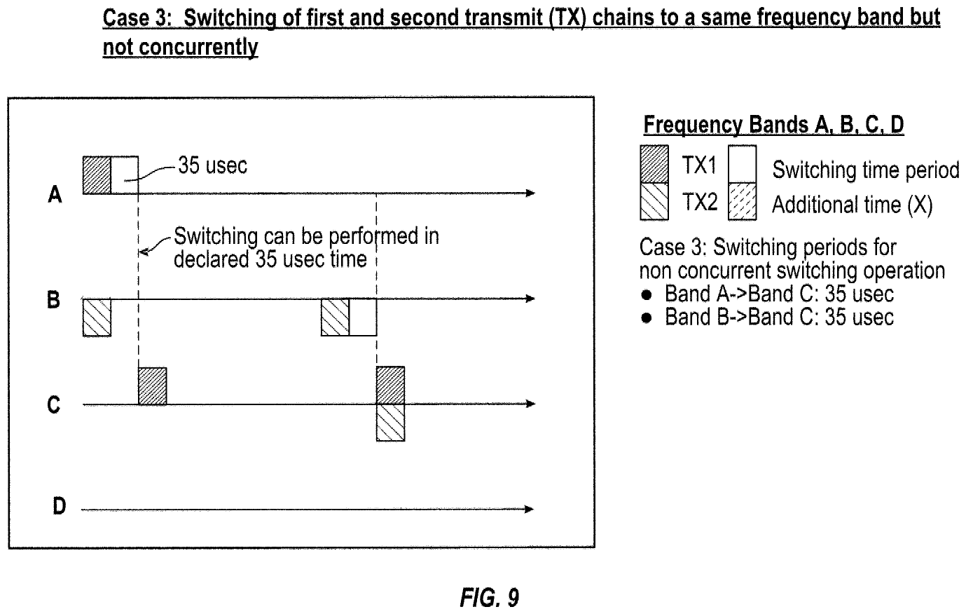

FIG. 9 depicts example switching time periods for non-concurrent switching of a first TX chain of a UE associated with a frequency band A and a second TX chain of a UE associated with a frequency band B to a same frequency band C. As depicted in FIG. 9, since the switching between the first TX chain associated with the frequency band A and the second TX chain associated with the frequency band B to the same frequency band C occur at different times, no additional or more time is needed (e.g., beyond a defined time duration per frequency band pair (e.g., 35 usec)) to complete the switching process and begin uplink transmissions. This is because, since there is no concurrent switching happening and the switching occurs at the different times for the different TX chains, uplink transmissions can be initiated after the switching process is completed for one TX chain as well (e.g., the switching of the first TX chain associated with the frequency band A to the frequency band C, or the switching of the first TX chain associated with the frequency band B to the frequency band C).

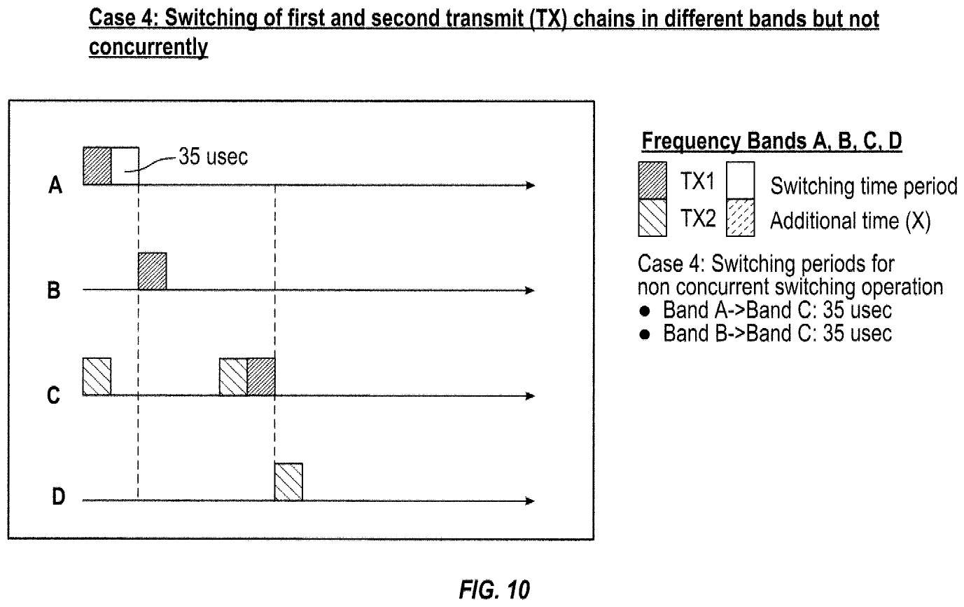

FIG. 10 depicts example switching time periods for non-concurrent switching of a first TX chain of a UE associated with a frequency band A and a second TX chain of the UE associated with a frequency band C in different frequency bands such as a frequency band B and a frequency band D. As depicted in FIG. 10, since the switching of the first TX chain associated with the frequency band A to the frequency band B and the second TX chain associated with the frequency band C to the frequency band D occur at different times, no additional or more time is needed (e.g., beyond a defined time duration per frequency band pair (e.g., 35 usec)) to complete the switching process and begin uplink transmissions. This is because, since there is no concurrent switching happening and the switching occurs at different times for different TX chains, uplink transmissions can be initiated after the switching process is completed for one TX chain as well (e.g., the switching of the first TX chain associated with the frequency band A to the frequency band B, or the switching of the first TX chain associated with the frequency band C to the frequency band D).

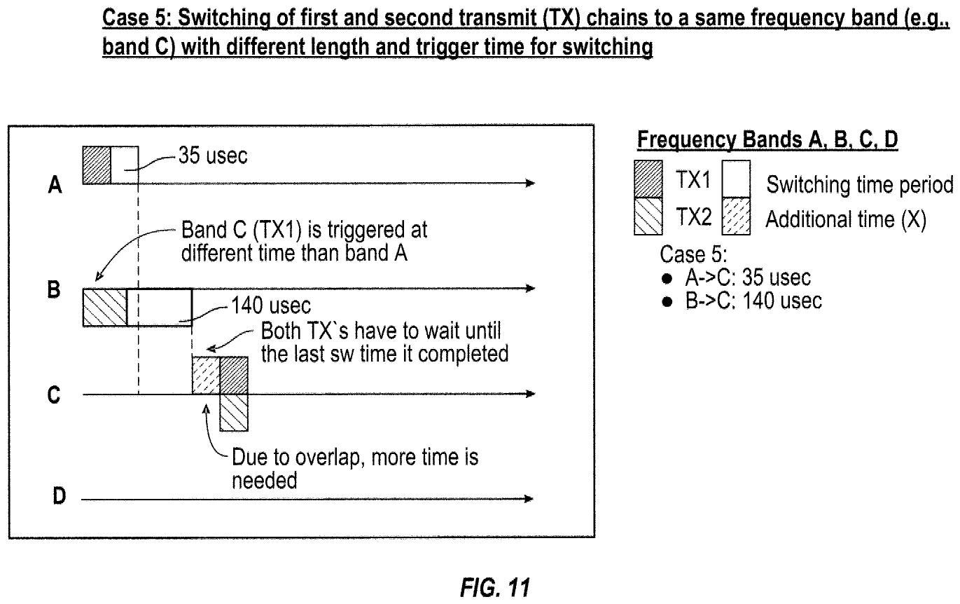

FIG. 11 depicts example switching time periods for switching of a first TX chain of a UE associated with a frequency band A and a second TX chain of a UE associated with a frequency band B to a same frequency band C, with different length and trigger time for switching. In this example case, due to the different length and the trigger time for the switching of the first TX chain associated with the frequency band A to the frequency band C (e.g., at a first trigger time) and the second TX chain associated with the frequency band B to the frequency band C (e.g., at a second trigger time), the first TX chain is switched (e.g., from the frequency band A to the frequency band C) and the second TX chain is switched (e.g., from the frequency band B to the frequency band C) at different time durations, and accordingly more or additional time may be needed (e.g., beyond a defined time duration per frequency band pair (e.g., 35 usec)) to complete the switching process and begin uplink transmissions. In the current example, the first TX chain is switched from the frequency band A to the frequency band C in 35 usec, and the second TX chain is switched from the frequency band B to the frequency band C in 140 usec (i.e., much more time beyond the defined time duration of 35 usec per frequency band pair to complete the switching process).

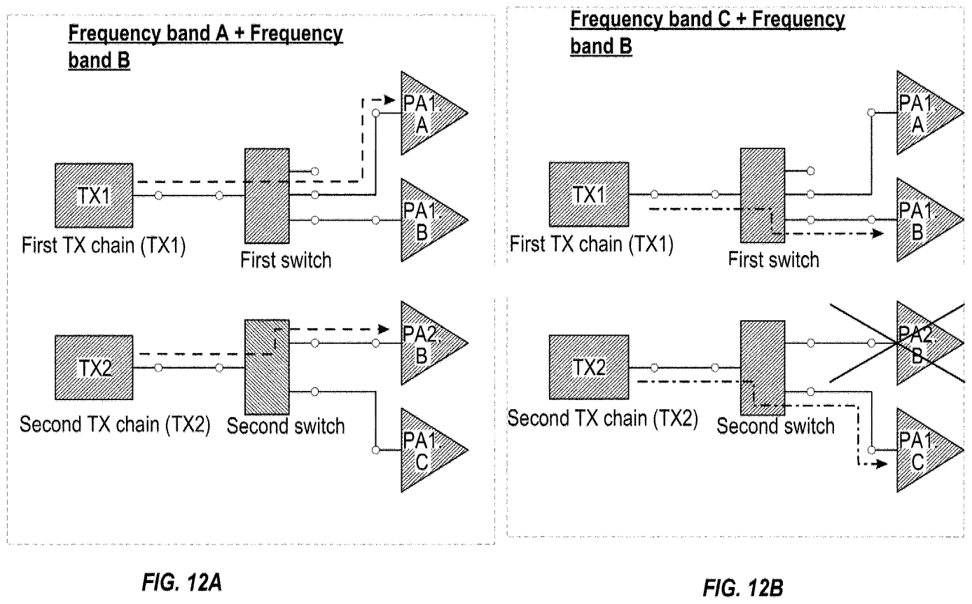

FIG. 12A depicts a first TX chain (TX1) of a UE associated with a frequency band A of a set of frequency bands and a second TX chain (TX2) of the UE associated with a frequency band B of the set of frequency bands. The set of frequency bands may also include a frequency band C and a frequency band D.

As further depicted in FIG. 12A, the first TX chain is associated with a first PA associated with the frequency band A (e.g., PA1.A) via a first switch. The first switch and the first PA associated with the frequency band A may be connected via a bus such as a serial bus. The second TX chain is associated with a second PA associated with the frequency band B (e.g., PA2.B) via a second switch. The second switch and the second PA associated with the frequency band B may be connected via the serial bus.

The UE implements a TX chain switching scheme to switch the TX chains between the set of frequency bands. For example, the UE implements the TX chain switching scheme to switch the TX chains from their current associations to the frequency band A and the frequency band B to the frequency band C and the frequency band B.

When the switching operation is completed after a certain switching time duration, the first TX chain is associated with the frequency band B and the second TX chain is associated with the frequency band C. For example, as illustrated in FIG. 12B, the first TX chain is associated with a first PA associated with the frequency band B (e.g., PA1.B) via the first switch. The first switch and the first PA associated with the frequency band B may be connected via the serial bus. The second TX chain is associated with a first PA associated with the frequency band C (PA1.C) via the second switch. The second switch and the first PA associated with the frequency band C may be connected via the serial bus.

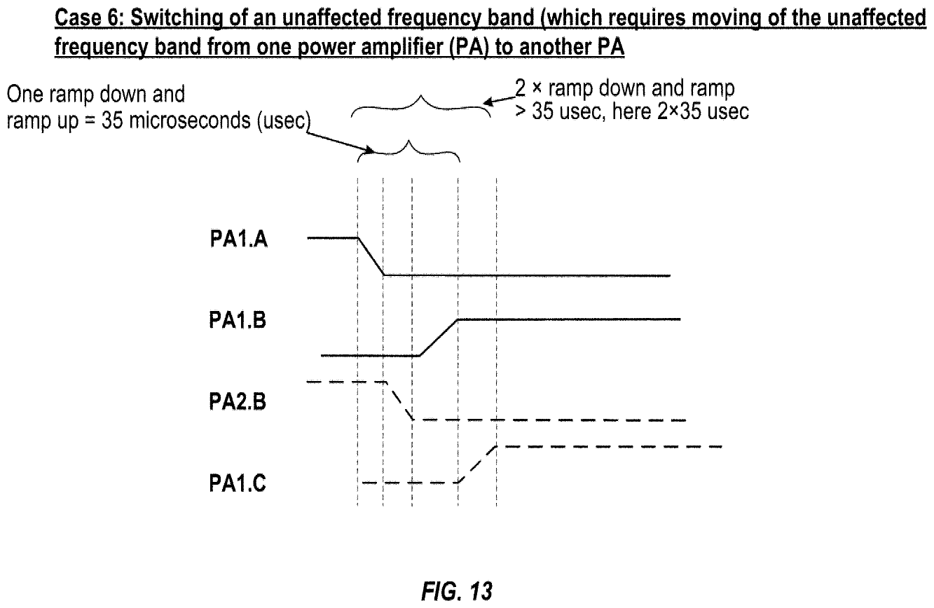

FIG. 13 depicts example timing diagram of different PAs associated with different frequency bands during switching of first and second TX chains of a UE (e.g., shown in FIG. 12A and FIG. 12B).

When the UE implements a TX chain switching scheme to switch the first and second TX chains from their current associations of a frequency band A and a frequency band B to a frequency band C and a frequency band B, although it appears that the UE only needs to switch one TX chain from the frequency band A to the frequency band C and the frequency band B is an unaffected frequency band, however, the frequency band B also needs to be switched due to a configuration or arrangement of the different PAS associated with the different frequency bands shown in FIG. 12A and FIG. 12B.

To switch the first and second TX chains, the UE may initially execute a first command to switch the first TX chain associated with the frequency band A to the frequency band B. The UE may then execute a second command to switch the second TX chain associated with the frequency band B to the frequency band C.

As depicted in FIG. 13, after the first command, there is a ramp down of a first PA associated with the frequency band A (e.g., PA1.A) followed by a ramp up of a first PA associated with the frequency band B (e.g., PA1.B). The time duration of the ramp down and the ramp up operation (or the switching time duration from the frequency band A to the frequency band B) is 35 usec (e.g., which is one of the defined values per frequency band pair).

After the second command (which is executed after the first command), there is a ramp down of a second PA associated with the frequency band B (e.g., PA2.B) followed by a ramp up of a first PA associated with the frequency band C (e.g., PA1.C). The time duration of the ramp down and the ramp up operation (or the switching time duration from the frequency band B to the frequency band C) is 70 usec (which is not one of the defined values per frequency band pair).

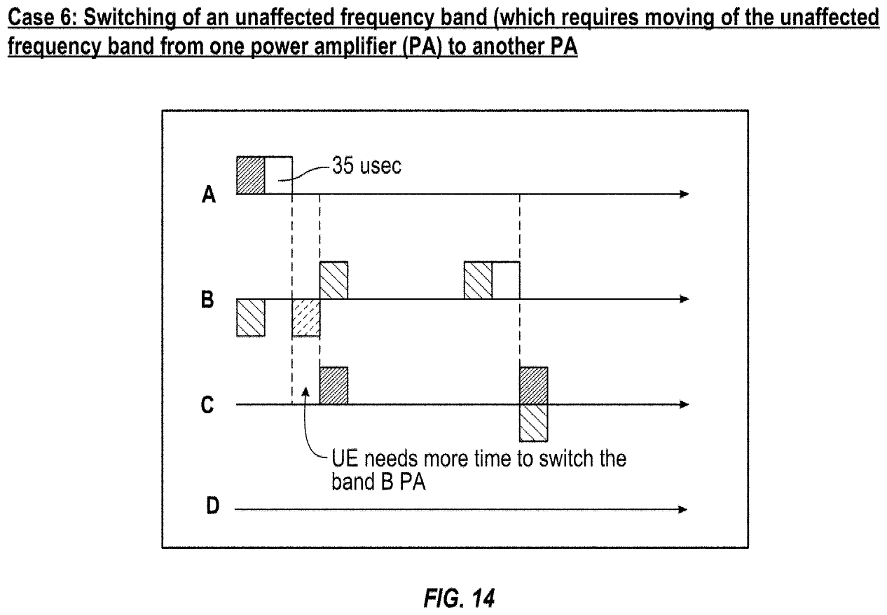

FIG. 14 depicts example switching time periods for switching of a first TX chain of a UE associated with a frequency band A to a frequency band B and a second TX chain of the UE associated with a frequency band B to a frequency band C (e.g., shown in FIG. 12A and FIG. 12B). As depicted in FIG. 14, since the switching between the first TX chain associated with the frequency band A to the frequency band B and the second TX chain associated with the frequency band B to the frequency band C occur at a same time, additional or more time is needed (e.g., beyond a defined time duration per frequency band pair (e.g., 35 usec)) to complete the switching process before uplink transmissions can be started. The additional time is required because, as depicted in FIG. 14, since the switching process of different TX chains start at different times, the concurrent switching process can not be completed during one of the defined time durations per frequency band pair.

### Aspects Related to Concurrent Switching of Transmit (TX) Chains Between Multiple Frequency Bands

Aspects of the present disclosure provide apparatuses, methods, processing systems, and computer-readable mediums for determining a switching time duration (or period) for a concurrent switching of transmit (TX) chains between multiple frequency bands.

For example, as per techniques proposed herein, when a user equipment (UE) determines about a potential occurrence of the concurrent switching of the TX chains between the multiple frequency bands, the UE may determine that more switching time is required (e.g., in addition to one of defined values per frequency band pair such as 35, 140, or 210 microseconds) to concurrently switch the TX chains between the multiple frequency bands. The UE may calculate the additional switching time based on one or more factors including, but not limited to, an internal configuration of the UE.

For example, in certain cases, although the UE may need the additional switching time to perform the concurrent switching of the TX chains between the numerous frequency bands, however, in some of these cases, the UE may actually be able to perform the switching in a less amount of time depending on what UE internal changes are needed based on the internal configuration of the UE. Accordingly, the techniques proposed herein enable the UE to usually leverage a fast switch time of the TX chains between the multiple frequency bands (and thereby preventing any throughput loss or reduced capacity), but also allow sufficient time when multiple operations may be needed.

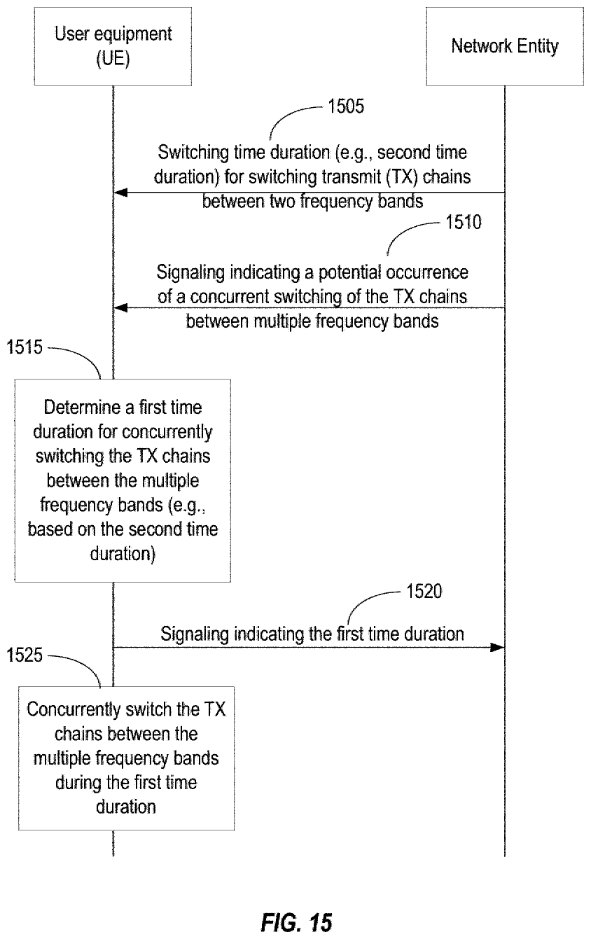

The techniques proposed herein may be understood with reference to FIGS. 15, 16, 17, 18 and 19.

As illustrated in FIG. 15, at 1505, a network entity (e.g., such as gNodeB (gNB)/base station (BS) 102 in wireless communication network 100 of FIG. 1) outputs, for transmission, signaling indicating a switching time duration (e.g., a second time duration) for switching TX chains (e.g., two or more TX chains such as a first TX chain and a second TX chain) between two frequency bands (e.g., a first frequency band and a second frequency band). A UE (e.g., such as UE 104 in wireless communication network 100 of FIG. 1) obtains the signaling from the network entity. In some cases, the UE may switch the TX chains between the two frequency bands during the second time duration.

In certain aspects, a value of the second time duration corresponds to one of a plurality of values being associated with the two frequency bands. The plurality of values includes at least a first value, a second value, and a third value. The first value corresponds to 35 microseconds. The second value corresponds to 140 microseconds. The third value corresponds to 210 microseconds. For example, the value of the second time duration may be 35, 140, or 210 microseconds.

At 1510, the network entity outputs, for transmission, to the UE signaling indicating a potential occurrence of a concurrent switching of the TX chains between multiple frequency bands. The multiple frequency bands include three or more frequency bands (e.g., at least the first frequency band, the second frequency band, and a third frequency band).

At 1515, the UE determines (or calculates) a first time duration for concurrently switching the TX chains between the multiple frequency bands, in response to the obtained signaling indicating the potential occurrence of the concurrent switching of the TX chains between the multiple frequency bands.

For example, when the UE may determine that the concurrent switching of the TX chains between the multiple frequency bands may occur, the UE may then also determine if an additional time is required along with the second time duration to concurrently switch the TX chains between the multiple frequency bands. When the UE determines that the additional time is required along with the second time duration to concurrently switch the TX chains between the multiple frequency bands, the UE defines a new UE capability field to indicate the additional time.

In certain aspects, the first time duration may correspond to the additional time required along with the second time duration to concurrently switch the TX chains between the multiple frequency bands.

In certain aspects, the UE determines a value of the first time duration based on a capability of the UE. For example, the UE may first determine the capability (e.g., a number of antennas, whether carrier aggregation (CA) is supported, etc.) of the UE and then calculate the value of the first time duration based on the determined capability of the UE.

In certain aspects, the UE determines a value of the first time duration based on one or more of the plurality of values. In one example, the UE may determine the value of the first time duration based on the first value and the second value. In another example, the UE may determine the value of the first time duration based on the first value and the third value. In another example, the UE may determine the value of the first time duration based on the second value and the third value. In another example, the UE may determine the value of the first time duration based on the first value, the second value, and the third value.

In certain aspects, the first time duration has a fixed (or constant) value. For example, the UE may receive an indication of the fixed value from the network entity.

In certain aspects, the first time duration may correspond to a total time duration required to concurrently switch the TX chains between the multiple frequency bands. For example, the total time duration may be equal to the second time duration and the additional time.

At 1520, the UE outputs, for transmission, signaling indicating the first time duration to the network entity. In some cases, the network entity may send an acknowledgement signal to the UE, in response to successfully obtaining the signaling indicating the first time duration.

At 1525, the UE concurrently switches the TX chains between the multiple frequency bands during the first time duration.

In certain aspects, when the UE may concurrently switch the TX chains between some frequency bands (e.g., the first frequency band, the second frequency band, and the third frequency band) of the multiple frequency bands, one or more frequency bands of the multiple frequency bands may be unaffected. For example, a fourth frequency band of the multiple frequency bands may be unaffected by the concurrent switching being associated with other frequency bands (e.g., the first frequency band, the second frequency band, and the third frequency band) of the multiple frequency bands. In such cases, the UE outputs, for transmission, one or more uplink transmissions via the unaffected fourth frequency band during the concurrent switching of the TX chains between the other frequency bands of the multiple frequency bands.

In certain aspects, the UE sends the signaling indicating the first time duration to the network entity when the UE supports an inter-band uplink CA on at least a pair of frequency bands (e.g., maybe within the other frequency bands) and the unaffected frequency band is configured for one or more uplink transmissions. For example, when the UE supports the inter-band uplink CA on a band pair within the first frequency band, the second frequency band, and the third frequency band, and the unaffected fourth frequency band is configured for the one or more uplink transmissions, the UE may need the additional time (e.g., along with the second time duration) to switch the TX chains between the first frequency band, the second frequency band, and the third frequency band.

In certain aspects, the UE sends the signaling indicating the first time duration when the UE supports dual uplinks on at least a pair of frequency bands (e.g., maybe within the other frequency bands) and the unaffected frequency band is configured for one or more uplink transmissions. For example, when the UE supports the dual uplinks on a band pair within the first frequency band, the second frequency band, and the third frequency band, and the unaffected fourth frequency band is configured for the one or more uplink transmissions, the UE may need the additional time (e.g., along with the second time duration) to switch the TX chains between the first frequency band, the second frequency band, and the third frequency band.

In certain aspects, the UE sends the signaling indicating the first time duration to the network entity when the UE supports an inter-band uplink CA on at least a pair of frequency bands (e.g., maybe within the other frequency bands) and the unaffected frequency band is scheduled for one or more uplink transmissions. For example, when the UE supports the inter-band uplink CA on a band pair within the first frequency band, the second frequency band, and the third frequency band, and the unaffected fourth frequency band is scheduled for the one or more uplink transmissions, the UE may need the additional time (e.g., along with the second time duration) to switch the TX chains between the first frequency band, the second frequency band, and the third frequency band.

In certain aspects, the UE sends the signaling indicating the first time duration when the UE supports dual uplinks on at least a pair of frequency bands (e.g., maybe within the other frequency bands) and the unaffected frequency band is scheduled for one or more uplink transmissions. For example, when the UE supports the dual uplinks on a band pair within the first frequency band, the second frequency band, and the third frequency band, and the unaffected fourth frequency band is scheduled for the one or more uplink transmissions, the UE may need the additional time (e.g., along with the second time duration) to switch the TX chains between the first frequency band, the second frequency band, and the third frequency band.

In certain aspects, the UE sends the signaling indicating the first time duration when: the UE supports an inter-band uplink CA on at least a pair of frequency bands (e.g., maybe within the other frequency bands), the UE supports dual uplinks on at least the pair of frequency bands (e.g., maybe within the other frequency bands), the unaffected frequency band supports two-layer uplink transmissions, and the unaffected frequency band is configured or scheduled for one or more uplink transmissions. For example, when the UE supports the inter-band uplink CA on a band pair within the first frequency band, the second frequency band, and the third frequency band; the UE supports the dual uplinks on the band pair within the first frequency band, the second frequency band, and the third frequency band; the unaffected fourth frequency band supports the two-layer uplink transmissions; and the unaffected fourth frequency band is configured or scheduled for the one or more uplink transmissions; the UE may need the additional time (e.g., along with the second time duration) to switch the TX chains between the first frequency band, the second frequency band, and the third frequency band.

### Example Operations of a User Equipment (UE)

FIG. 16 shows an example of a method 1600 for wireless communications at a UE, such as a UE 104 of FIGS. 1 and 3.

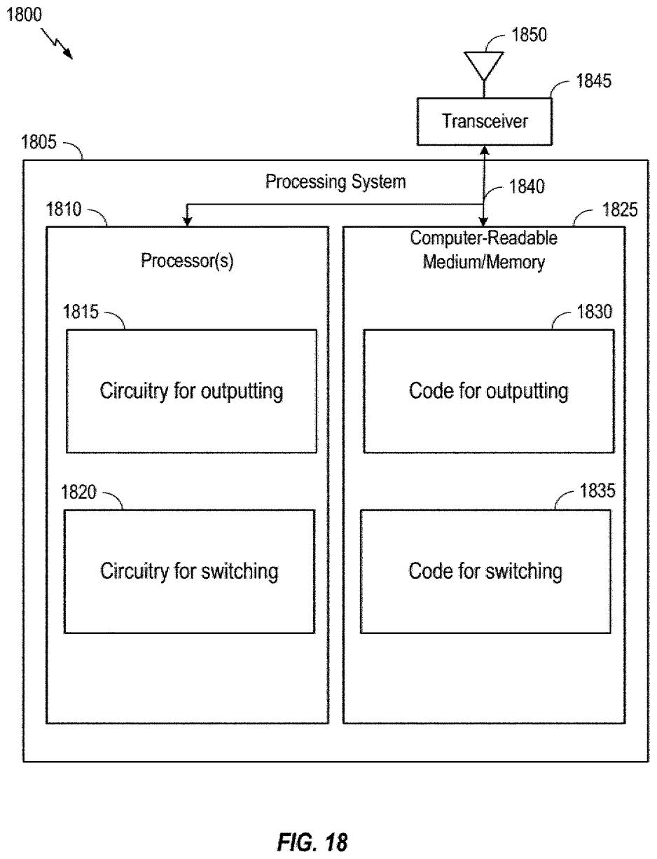

Method 1600 begins at step 1605 with outputting, for transmission, signaling indicating a first time duration. In some cases, the operations of this step refer to, or may be performed by, circuitry for outputting and/or code for outputting as described with reference to FIG. 18.

Method 1600 then proceeds to step 1610 with concurrently switching TX chains between multiple frequency bands during at least the first time duration. In some cases, the operations of this step refer to, or may be performed by, circuitry for switching and/or code for switching as described with reference to FIG. 18.

In certain aspects, method 1600 further includes obtaining signaling indicating a potential occurrence of a concurrent switching of the TX chains between the multiple frequency bands.

In certain aspects, the multiple frequency bands include three or more frequency bands.

In certain aspects, method 1600 further includes obtaining signaling indicating a second time duration and switching the TX chains between two frequency bands during at least the second time duration.

In certain aspects, a value of the second time duration corresponds to one of a plurality of values being associated with the two frequency bands.

In certain aspects, the first time duration corresponds to an additional time required along with the second time duration to concurrently switch the TX chains between the multiple frequency bands.

In certain aspects, a value of the first time duration is based on a capability of the UE.

In certain aspects, a value of the first time duration is based on one or more of the plurality of values.

In certain aspects, the first time duration has a fixed value.

In certain aspects, the first time duration corresponds to a total time duration required to concurrently switch the TX chains between the multiple frequency bands.

In certain aspects, a frequency band of the multiple frequency bands is unaffected by a concurrent switching being associated with other frequency bands of the multiple frequency bands.

In certain aspects, method 1600 further includes outputting, for transmission, one or more uplink transmissions via the unaffected frequency band during the concurrent switching of the TX chains between the other frequency bands of the multiple frequency bands.

In certain aspects, the signaling is outputted when the UE supports an inter-band uplink CA on at least a pair of frequency bands (e.g., maybe within the other frequency bands) and the unaffected frequency band is scheduled for one or more uplink transmissions.

In certain aspects, the signaling is outputted when the UE supports dual uplinks on at least a pair of frequency bands(e.g., maybe within the other frequency bands) and the unaffected frequency band is scheduled for one or more uplink transmissions.

In certain aspects, the signaling is outputted when: the UE supports an inter-band uplink CA on at least a pair of frequency bands (e.g., maybe within the other frequency bands), the UE supports dual uplinks on at least the pair of frequency bands (e.g., maybe within the other frequency bands), or the unaffected frequency band supports two-layer uplink transmissions.

In certain aspects, the signaling is outputted when: at least one of the UE supports an inter-band uplink CA on at least a pair of frequency bands (e.g., maybe within the other frequency bands), the UE supports dual uplinks on at least the pair of frequency bands (e.g., maybe within the other frequency bands), or the unaffected frequency band supports two-layer uplink transmissions; and the UE is scheduled for one or more uplink transmissions on the unaffected frequency band during the first time duration.

In one aspect, method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative steps are possible consistent with this disclosure.

### Example Operations of a Network Entity

FIG. 17 shows an example of a method 1700 for wireless communications at a network entity, such as a BS 102 of FIGS. 1 and 3, or a disaggregated BS as discussed with respect to FIG. 2.

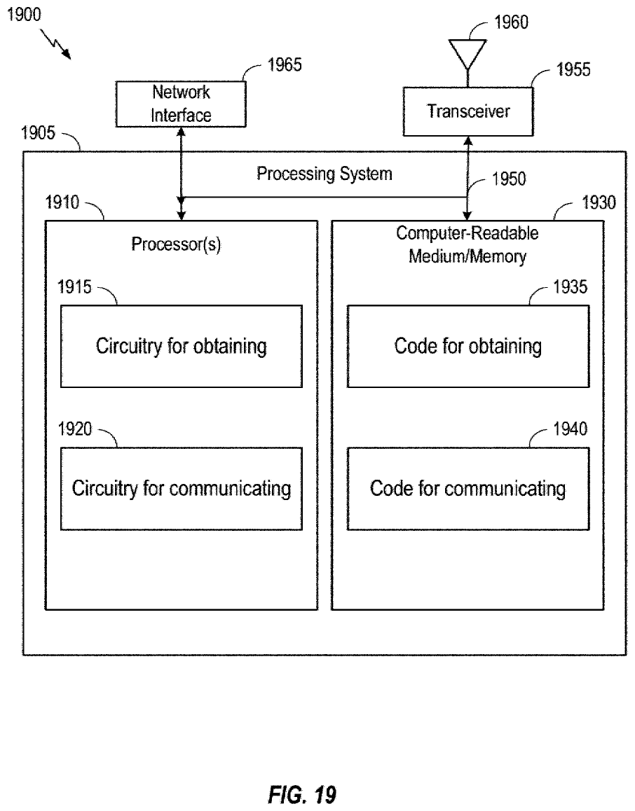

Method 1700 begins at step 1705 with obtaining, from a UE, signaling indicating a first time duration for the UE to concurrently switch TX chains between multiple frequency bands. In some cases, the operations of this step refer to, or may be performed by, circuitry for obtaining and/or code for obtaining as described with reference to FIG. 19.

Method 1700 then proceeds to step 1710 with communicating with the UE, in accordance with the indication. In some cases, the operations of this step refer to, or may be performed by, circuitry for communicating and/or code for communicating as described with reference to FIG. 19.

In certain aspects, the method 1700 further includes outputting, for transmission, signaling indicating a potential occurrence of a concurrent switching of the TX chains between the multiple frequency bands.

In certain aspects, the multiple frequency bands include three or more frequency bands.

In certain aspects, the method 1700 further includes outputting, for transmission, signaling indicating a second time duration to switch the TX chains between two frequency bands.

In certain aspects, a value of the second time duration corresponds to one of a plurality of values being associated with the two frequency bands.

In certain aspects, the first time duration corresponds to an additional time required along with the second time duration to concurrently switch the TX chains between the multiple frequency bands.

In certain aspects, a value of the first time duration is based on a capability of the UE.

In certain aspects, a value of the first time duration is based on one or more of the plurality of values.

In certain aspects, the first time duration has a fixed value.

In certain aspects, the first time duration corresponds to a total time duration required to concurrently switch the TX chains between the multiple frequency bands.

In one aspect, method 1700, or any aspect related to it, may be performed by an apparatus, such as communications device 1900 of FIG. 19, which includes various components operable, configured, or adapted to perform the method 1700. Communications device 1900 is described below in further detail.

Note that FIG. 17 is just one example of a method, and other methods including fewer, additional, or alternative steps are possible consistent with this disclosure.

### Example Communications Devices

FIG. 18 depicts aspects of an example communications device 1800. In some aspects, communications device 1800 is a user equipment (UE), such as UE 104 described above with respect to FIGS. 1 and 3.

The communications device 1800 includes a processing system 1805 coupled to the transceiver 1845 (e.g., a transmitter and/or a receiver). The transceiver 1845 is configured to transmit and receive signals for the communications device 1800 via the antenna 1850, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 358, transmit processor 364, TX MIMO processor 366, and/or controller/processor 380, as described with respect to FIG. 3. The one or more processors 1810 are coupled to a computer-readable medium/memory 1825 via a bus 1840. In certain aspects, the computer-readable medium/memory 1825 is configured to store instructions (e.g., computer-executable code) that when executed by the one or more processors 1810, cause the one or more processors 1810 to perform the method 1600 described with respect to FIG. 16, or any aspect related to it. Note that reference to a processor performing a function of communications device 1800 may include one or more processors 1810 performing that function of communications device 1800.

In the depicted example, computer-readable medium/memory 1825 stores code (e.g., executable instructions), such as code for outputting 1830 and code for switching 1835. Processing of the code for outputting 1830 and code for switching 1835 may cause the communications device 1800 to perform the method 1600 described with respect to FIG. 16, or any aspect related to it.

The one or more processors 1810 include circuitry configured to implement (e.g., execute) the code stored in the computer-readable medium/memory 1825, including circuitry such as circuitry for outputting 1815 and circuitry for switching 1820. Processing with circuitry for outputting 1815 and circuitry for switching 1820 may cause the communications device 1800 to perform the method 1600 described with respect to FIG. 16, or any aspect related to it.

Various components of the communications device 1800 may provide means for performing the method 1600 described with respect to FIG. 16, or any aspect related to it. For example, means for transmitting, sending or outputting for transmission may include transceivers 354 and/or antenna(s) 352 of the UE 104 illustrated in FIG. 3 and/or the circuitry for outputting 1815, the code for outputting 1830, the transceiver 1845 and the antenna 1850 of the communications device 1800 in FIG. 18. Means for receiving or obtaining may include transceivers 354 and/or antenna(s) 352 of the UE 104 illustrated in FIG. 3 and/or the transceiver 1845 and the antenna 1850 of the communications device 1800 in FIG. 18. Means for switching may include receive processor 358, controller/processor 380, and/or transmit processor 364 of the UE 104 illustrated in FIG. 3 and/or the circuitry for switching 1820, the code for switching 1835, the processing system 1805, and the transceiver 1845 of the communications device 1800 in FIG. 18.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive MIMO processors, modulators, demodulators, and the like, such as depicted in the examples in FIG. 3. Notably, FIG. 18 is an example, and many other examples and configurations of communication device 1800 are possible.

FIG. 19 depicts aspects of an example communications device 1900. In some aspects, communications device 1900 is a network entity, such as BS 102 of FIGS. 1 and 3, or a disaggregated base station as discussed with respect to FIG. 2.

The communications device 1900 includes a processing system 1905 coupled to the transceiver 1955 (e.g., a transmitter and/or a receiver) and/or a network interface 1965. The transceiver 1655 is configured to transmit and receive signals for the communications device 1900 via the antenna 1960, such as the various signals as described herein. The network interface 1965 is configured to obtain and send signals for the communications device 1900 via communication link(s), such as a backhaul link, midhaul link, and/or fronthaul link as described herein, such as with respect to FIG. 2. The processing system 1905 may be configured to perform processing functions for the communications device 1900, including processing signals received and/or to be transmitted by the communications device 1900.

The processing system 1905 includes one or more processors 1910. In various aspects, one or more processors 1910 may be representative of one or more of receive processor 338, transmit processor 320, TX MIMO processor 330, and/or controller/processor 340, as described with respect to FIG. 3. The one or more processors 1910 are coupled to a computer-readable medium/memory 1930 via a bus 1950. In certain aspects, the computer-readable medium/memory 1930 is configured to store instructions (e.g., computer-executable code) that when executed by the one or more processors 1910, cause the one or more processors 1910 to perform the method 1700 described with respect to FIG. 17, or any aspect related to it. Note that reference to a processor of communications device 1900 performing a function may include one or more processors 1910 of communications device 1900 performing that function.

In the depicted example, the computer-readable medium/memory 1930 stores code (e.g., executable instructions), such as code for obtaining 1935 and code for communicating 1940. Processing of the code for obtaining 1935 and code for communicating 1940 may cause the communications device 1900 to perform the method 1700 described with respect to FIG. 17, or any aspect related to it.

The one or more processors 1910 include circuitry configured to implement (e.g., execute) the code stored in the computer-readable medium/memory 1930, including circuitry such as circuitry for obtaining 1915 and circuitry for communicating 1920. Processing with circuitry for obtaining 1915 and circuitry for communicating 1920 may cause the communications device 1900 to perform the method 1700 as described with respect to FIG. 17, or any aspect related to it.

Various components of the communications device 1900 may provide means for performing the method 1700 as described with respect to FIG. 17, or any aspect related to it. Means for transmitting, sending or outputting for transmission may include transceivers 332 and/or antenna(s) 334 of the BS 102 illustrated in FIG. 3 and/or the transceiver 1955 and the antenna 1960 of the communications device 1900 in FIG. 19. Means for receiving or obtaining may include transceivers 332 and/or antenna(s) 334 of the BS 102 illustrated in FIG. 3 and/or the circuitry for obtaining 1915, the code for obtaining 1935, the transceiver 1955 and the antenna 1960 of the communications device 1900 in FIG. 19. Means for communicating may include receive processor 338, controller/processor 340, and/or transmit processor 320 of the BS 102 illustrated in FIG. 3 and/or the circuitry for communicating 1920, the code for communicating 1940, the processing system 1905, and the transceiver 1955 of the communications device 1900 in FIG. 19.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 19 is an example, and many other examples and configurations of communication device 1900 are possible.

### Example Clauses

Implementation examples are described in the following numbered clauses:

Clause 1: A method for wireless communications at a user equipment (UE), comprising: outputting, for transmission, signaling indicating a first time duration; and concurrently switching transmit (TX) chains between multiple frequency bands during at least the first time duration.

Clause 2: The method of Clause 1, further comprising obtaining signaling indicating a potential occurrence of a concurrent switching of the TX chains between the multiple frequency bands.

Clause 3: The method of Clause 1, wherein the multiple frequency bands comprise three or more frequency bands.

Clause 4: The method of Clause 1, further comprising: obtaining signaling indicating a second time duration; and switching the TX chains between two frequency bands during at least the second time duration.

Clause 5: The method of Clause 4, wherein a value of the second time duration corresponds to one of a plurality of values being associated with the two frequency bands.

Clause 6: The method of Clause 4, wherein the first time duration corresponds to an additional time required along with the second time duration to concurrently switch the TX chains between the multiple frequency bands.

Clause 7: The method of Clause 1, wherein a value of the first time duration is based on a capability of the UE.

Clause 8: The method of Clause 5, wherein a value of the first time duration is based on one or more of the plurality of values.

Clause 9: The method of Clause 1, wherein the first time duration has a fixed value.

Clause 10: The method of Clause 1, wherein the first time duration corresponds to a total time duration required to concurrently switch the TX chains between the multiple frequency bands.

Clause 11: The method of Clause 1, wherein a frequency band of the multiple frequency bands is unaffected by a concurrent switching being associated with other frequency bands of the multiple frequency bands.

Clause 12: The method of Clause 11, further comprising outputting, for transmission, one or more uplink transmissions via the unaffected frequency band during the concurrent switching of the TX chains between the other frequency bands of the multiple frequency bands.

Clause 13: The method of Clause 11, wherein the signaling is outputted when the UE supports an inter-band uplink carrier aggregation (CA) on at least a pair of frequency bands and the unaffected frequency band is scheduled for one or more uplink transmissions.

Clause 14: The method of Clause 11, wherein the signaling is outputted when the UE supports dual uplinks on at least a pair of frequency bands and the unaffected frequency band is scheduled for one or more uplink transmissions.

Clause 15: The method of Clause 11, wherein the signaling is outputted when: the UE supports an inter-band uplink carrier aggregation (CA) on at least a pair of frequency bands, the UE supports dual uplinks on at least the pair of frequency bands, or the unaffected frequency band supports two-layer uplink transmissions.

Clause 16: The method of Clause 11, wherein the signaling is outputted when: at least one of the apparatus supports an inter-band uplink carrier aggregation (CA) on at least a pair of frequency bands, the apparatus supports dual uplinks on at least the pair of frequency bands, or the unaffected frequency band supports two-layer uplink transmissions; and the UE is scheduled for one or more uplink transmissions on the unaffected frequency band during the first time duration.

Clause 17: A method for wireless communications at a network entity, comprising: obtaining, from a user equipment (UE), signaling indicating a first time duration for the UE to concurrently switch transmit (TX) chains between multiple frequency bands; and communicating with the UE, in accordance with the indication.

Clause 18: The method of Clause 17, further comprising outputting, for transmission, signaling indicating a potential occurrence of a concurrent switching of the TX chains between the multiple frequency bands.

Clause 19: The method of Clause 17, wherein the multiple frequency bands comprise three or more frequency bands.

Clause 20: The method of Clause 17, further comprising outputting, for transmission, signaling indicating a second time duration to switch the TX chains between two frequency bands.

Clause 21: The method of Clause 20, wherein a value of the second time duration corresponds to one of a plurality of values being associated with the two frequency bands.

Clause 22: The method of Clause 20, wherein the first time duration corresponds to an additional time required along with the second time duration to concurrently switch the TX chains between the multiple frequency bands.

Clause 23: The method of Clause 17, wherein a value of the first time duration is based on a capability of the UE.

Clause 24: The method of Clause 21, wherein a value of the first time duration is based on one or more of the plurality of values.

Clause 25: The method of Clause 17, wherein the first time duration has a fixed value.

Clause 26: The method of Clause 17, wherein the first time duration corresponds to a total time duration required to concurrently switch the TX chains between the multiple frequency bands.

Clause 27: An apparatus, comprising: a memory comprising executable instructions; and a processor configured to execute the executable instructions and cause the apparatus to perform a method in accordance with any one of Clauses 1-26.

Clause 28: An apparatus, comprising means for performing a method in accordance with any one of Clauses 1-26.

Clause 29: A non-transitory computer-readable medium comprising executable instructions that, when executed by a processor of an apparatus, cause the apparatus to perform a method in accordance with any one of Clauses 1-26.

Clause 30: A computer program product embodied on a computer-readable storage medium comprising code for performing a method in accordance with any one of Clauses 1-26.

Clause 31: A user equipment (UE), comprising: at least one transceiver; a memory comprising executable instructions; and a processor configured to execute the executable instructions and cause the UE to perform a method in accordance with any one of Clauses 1-16, wherein the at least one transceiver is configured to transmit signaling indicating a first time duration.

Clause 32: A network entity, comprising: at least one transceiver; a memory comprising executable instructions; and a processor configured to execute the executable instructions and cause the network entity to perform a method in accordance with any one of Clauses 17-26, wherein the at least one transceiver is configured to receive from a user equipment (UE) signaling indicating a first time duration for the UE to concurrently switch transmit (TX) chains between multiple frequency bands and communicate with the UE in accordance with the indication.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications, comprising:
at least one memory comprising computer-executable instructions; and
at least one processor configured to execute the computer-executable instructions to cause the apparatus to:
output, for transmission, signaling indicating a first time duration; and
concurrently switch transmit (TX) chains between multiple frequency bands during at least the first time duration.

2. The apparatus of claim 1, wherein the at least one processor is further configured to execute the computer-executable instructions to cause the apparatus to obtain signaling indicating a potential occurrence of a concurrent switching of the TX chains between the multiple frequency bands.

3. The apparatus of claim 1, wherein the multiple frequency bands comprise three or more frequency bands.

4. The apparatus of claim 1, wherein the at least one processor is further configured to execute the computer-executable instructions to cause the apparatus to:
obtain signaling indicating a second time duration; and
switch the TX chains between two frequency bands during at least the second time duration.

5. The apparatus of claim 4, wherein a value of the second time duration corresponds to one of a plurality of values being associated with the two frequency bands.

6. The apparatus of claim 4, wherein the first time duration corresponds to an additional time required along with the second time duration to concurrently switch the TX chains between the multiple frequency bands.

7. The apparatus of claim 1, wherein at least one of:
a value of the first time duration is based on a capability of the apparatus;
the first time duration has a fixed value;
the first time duration corresponds to a total time duration required to concurrently switch the TX chains between the multiple frequency bands; or
a frequency band of the multiple frequency bands is unaffected by a concurrent switching being associated with other frequency bands of the multiple frequency bands.

8. The apparatus of claim 5, wherein a value of the first time duration is based on one or more of the plurality of values.

9-11. (canceled)

12. The apparatus of claim 1, wherein:
a frequency band of the multiple frequency bands is unaffected by a concurrent switching being associated with other frequency bands of the multiple frequency bands; and
the at least one processor is further configured to execute the computer-executable instructions to cause the apparatus to output, for transmission, one or more uplink transmissions via the unaffected frequency band during the concurrent switching of the TX chains between the other frequency bands of the multiple frequency bands.

13. The apparatus of claim 11, wherein the signaling is outputted when the apparatus supports an inter-band uplink carrier aggregation (CA) on at least a pair of frequency bands and the unaffected frequency band is scheduled for one or more uplink transmissions.

14. The apparatus of claim 11, wherein the signaling is outputted when the apparatus supports dual uplinks on at least a pair of frequency bands and the unaffected frequency band is scheduled for one or more uplink transmissions.

15. The apparatus of claim 11, wherein the signaling is outputted when:
the apparatus supports an inter-band uplink carrier aggregation (CA) on at least a pair of frequency bands,
the apparatus supports dual uplinks on at least the pair of frequency bands, or
the unaffected frequency band supports two-layer uplink transmissions.

16. The apparatus of claim 11, wherein the signaling is outputted when:
at least one of the apparatus supports an inter-band uplink carrier aggregation (CA) on at least a pair of frequency bands, the apparatus supports dual uplinks on at least the pair of frequency bands, or the unaffected frequency band supports two-layer uplink transmissions; and
the UE is scheduled for one or more uplink transmissions on the unaffected frequency band during the first time duration.

17. A user equipment (UE), comprising:
at least one transceiver;
at least one memory comprising computer-executable instructions; and
at least one processor configured to execute the computer-executable instructions to cause the UE to:
transmit, via the at least one transceiver, signaling indicating a first time duration; and
concurrently switch transmit (TX) chains between multiple frequency bands during at least the first time duration.

18. An apparatus for wireless communications, comprising:
at least one memory comprising computer-executable instructions; and
at least one processor configured to execute the computer-executable instructions to cause the apparatus to:
obtain, from a user equipment (UE), signaling indicating a first time duration for the UE to concurrently switch transmit (TX) chains between multiple frequency bands; and
communicate with the UE, in accordance with the indication.

19. The apparatus of claim 18, wherein the at least one processor is further configured to execute the computer-executable instructions to cause the apparatus to output, for transmission, signaling indicating a potential occurrence of a concurrent switching of the TX chains between the multiple frequency bands.

20. The apparatus of claim 18, wherein at least one of:
the multiple frequency bands comprise three or more frequency bands;
a value of the first time duration is based on a capability of the UE;
the first time duration has a fixed value; or
the first time duration corresponds to a total time duration required to concurrently switch the TX chains between the multiple frequency bands.

21. The apparatus of claim 18, wherein the at least one processor is further configured to execute the computer-executable instructions to cause the apparatus to output, for transmission, signaling indicating a second time duration to switch the TX chains between two frequency bands.

22. The apparatus of claim 21, wherein at least one of:
a value of the second time duration corresponds to one of a plurality of values being associated with the two frequency bands; or
the first time duration corresponds to an additional time required along with the second time duration to concurrently switch the TX chains between the multiple frequency bands.

23-24. (canceled)

25. The apparatus of claim 22, wherein a value of the first time duration is based on one or more of the plurality of values.

26-28. (canceled)
